(19) United States
(12) Patent Application Publication
(10) Pub. No.: US 2008/0270892 A1
(43) Pub. Date: Oct. 30, 2008

(54) DATA STORAGE SYSTEM

(76) Inventor: Christine Rose WARNER, Bedford (GB)

Correspondence Address: YOUNG LAW FIRM, P.C.;ALAN W. YOUNG, 4370 ALPINE ROAD, SUITE 106, PORTOLA VALLEY, CA, 94028, US

(21) Appl. No.: 11/971,857

(22) Filed: Jan. 9, 2008

(30) Foreign Application Priority Data
Jan. 10, 2007 (GB) 0700392.4

(51) Int. Cl. G06F 17/00

(52) U.S. Cl. 715/249

(57) ABSTRACT

This invention relates to a data storage system for use with a multi layered package in which each particular document in a selection of documents comprises a number of component elements or images that are selectable from at least two variants. Each document is stored on a storage medium in a readily accessible format and each document includes the appropriate coding to activate the variants selected for use with that document and when opened a particular document activates the various variant components for the document and these are appropriately sized and formatted for the particular document and displayed in the opened document.

### BACKGROUND OF THE INVENTION

This application claims priority under 35 U.S.C. §119(a)-(d) to GB Patent Application No. 0700392.4, filed Jan. 10, 2007, which application is hereby incorporated herein by reference in its entirety.

This invention relates to a data storage system which includes a method and means for the storage or keeping of data in a storage medium, and, in particular, to the storing and keeping of data making up the finalized file.

Over recent years there has been a marked increase the number of electronic media based products such as CD based products and website based products. A number of these products provide an end user product such as a design or a drawing that is made up of components that are electronically assembled to provide the final product to the particular arrangement designed by the user and made up of components provided on the CD or website. A majority, if not all of these products are graphics based and the final product is formed from several layers, each layer having one component of the final design.

With the current products available in the high street, or via mail order each of the desired end design variations is stored on the disk as a separate image, a multi layered image. Apart from the fact this is not very efficient and even with the improvement in storage medium currently available, such separate images rapidly occupy all the available space on the disk. Only when the number of separate images or variations to be stored is not high is such a storage scheme manageable. However, the customer is becoming more and more demanding and, therefore, the end products supplied have to be of increasingly better quality and also more flexible with an increase in the number of variants or variation layers that have to be supplied as well as the quality of the design. This, as will be well appreciated, places a significant strain on the storage medium and the operational speed of the computer.

Further, as will be appreciated, where the number of variants is high or the number of possible variations is high, this can lead to significant data storage problems. In the past, file compression has enabled the end problem to be avoided. However, this will not continue for too much longer as the demand increases.

### SUMMARY OF THE INVENTION

According to an embodiment thereof, the present invention is a data storage system for use in forming documents, comprising a plurality of component elements or images that are selectable from at least two variants, and the components being overlaid to form a document having a plurality of layers, wherein each component and document is stored on a storage medium in a readily accessible format and each document includes the appropriate coding to activate the components selected for use with the document wherein, when opened, the document activates the components of the document, formatting them to the appropriate size, overlaying the components and displaying the opened document.

According to further embodiments, the layers of the document may include an outline layer defining an outline shape for the design as well as specific design layers, the design including at least two layers. The outline layer may include a layer that is configured to produce envelopes of predetermined shapes and sizes. The outline layer may be configured so that only the part of subsequent layers corresponding to the outline shape may be visible to a user. Each of a number of designs stored on the storage medium and each of which designs may include a selection of layers each of which layers may be selected from at least two variants may be stored in a readily accessible format and each design may include an appropriate coding to activate the variants selected for use with the design wherein, when opened, a particular design activates the various variant components making up the design and the activated variant components are appropriately sized and formatted for the particular design and displayed.

According to another embodiment, the present invention is a data storage system for use with component overlaid design images in which a design image is created from a number of separate components layers that are selected and overlaid one over another to create the design image, and wherein the created design image includes a number of overlaid layers and each of the layers has corresponding selectable images which are storable as separate files on a storage medium and wherein the design image is created by assembly of the component layers and the information for a created design image is stored as a series of instruction for the creation of the design image. The layers of the created design image may include an outline layer defining an outline shape for the design as well as specific design layers, the design including at least two layers. The outline layer may include a layer that may be configured to produce envelopes of predetermined shapes and sizes. The outline layer may be configured so that only the part of subsequent layers corresponding to the outline shape may be visible to a user. Each of a number of designs stored on the storage medium and each of which designs may include a selection of layers each of which layers is selected from at least two variants may be stored in a readily accessible format and each design may includes an appropriate coding to activate the variants selected for use with the design wherein, when opened, a particular design activates the various variant components making up the design and the activated variant components are appropriately sized and formatted for the particular design and displayed.

### BRIEF DESCRIPTION OF THE DRAWINGS

FIG. 1 shows a data storage system for use in forming documents, according to embodiments of the present inventions.

FIG. 2 shows an exemplary outline layer of a design, according to an embodiment of the present inventions.

### DETAILED DESCRIPTION

The present invention is concerned with providing a data management system for this type of application that alleviates, if not overcomes, the storage problem detailed above. Further, the invention is concerned with providing a data storage system that enhances the operational characteristics of a system.

In accordance with an embodiment of the present invention, there is provided a data storage system for use in forming documents which comprise a number of component elements or images that are selectable from at least two variants, and the components are overlaid to form a document wherein each component and document is stored on a storage medium in a readily accessible format and each document includes the appropriate coding 112, 114 as shown at to activate the components selected for use with that document wherein, when opened, a particular document activates the components of the document formatting them to the appropriate size and overlaying the components displaying the opened document.

In a preferred embodiment of the present invention, data representing each of a number of designs stored on the CD, each of which designs comprises a selection of components or overlays, each of which is selected from at least two variants, is stored in a readily accessible format and each design includes the appropriate coding 112, 114 to activate the variants selected for use with that design wherein, when opened, a particular design activates the various variant components making up the design and these are appropriately sized and formatted for the particular design and displayed.

In one particular application of the current invention, there is provided a data storage system for use with component overlaid design images in which a created design image produced by the system is created from a number of separate image components that are selected and overlaid one over another to create the created design image and wherein the format of the structure of the created image has a number of overlaid layers and each of the layers has corresponding selectable images which are storable as separate files on a medium and wherein the created images are created by assembly of the component layers and the information for a created image is stored as a series of instruction for the creation of the created design.

The present invention has been particularly developed for use in the area of craft design CD's. In this area, a user constructs a design by overlaying several components. The crafter using the present invention is encouraged to assemble a design from the components available. Normally the components available will be broken down into several constituent parts or categories of overlays. These layers may include an overall shape or outline for the design as well as specific design layers, and each created design will consist of at least two overlays.

In one example of the invention, the outline layer may include a layer that is configured to produce envelopes of varying shapes and sizes. The constructed envelopes may conform to the standard envelope sizes. It will be readily understood that the outline overlay may be used to provide shaping for any suitable article or just shaping.

In a preferred embodiment of the invention, the outline layer is configured so that only the part of the subsequent layers corresponding to the outline shape is visible to the user.

The present invention is usable with any electronic storage medium, for example, CD, DVD or hard disk memory.

In a further aspect of the invention, the invention includes the storage media with information/data stored thereon for use in accordance with the present invention.

The invention will now be illustrated by way of description of an example in accordance with the present invention.

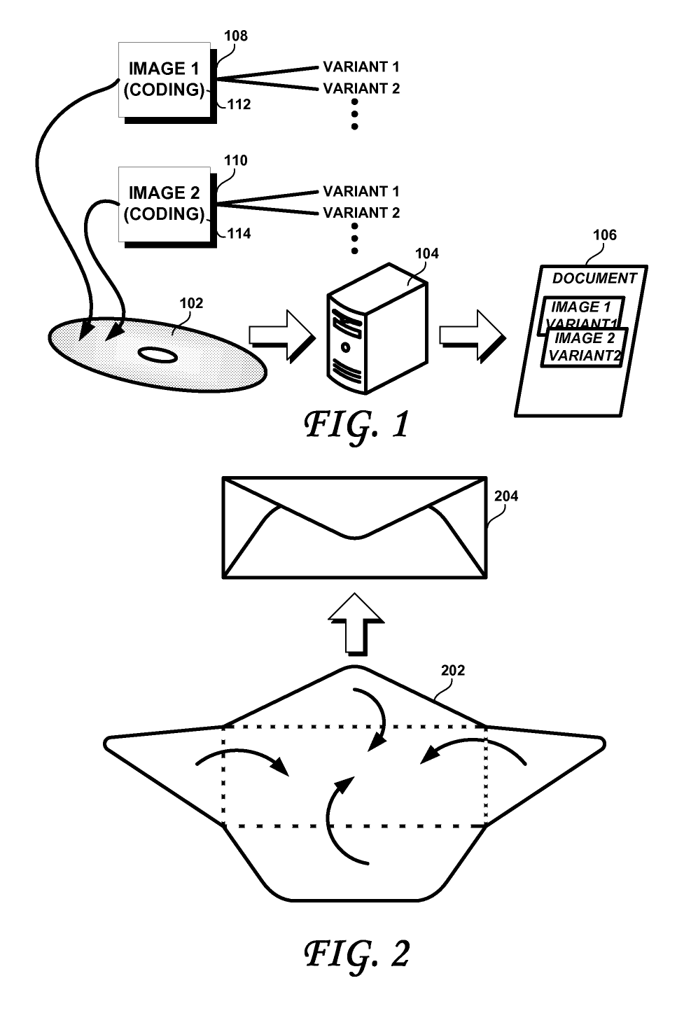

The present invention has been developed for use in the supply of CD's such as shown at 102 in FIG. 1 or other storage media that carry designs for use by a craft designer and shall be described in that sense although it will be readily understood by those skilled in the art that the invention has uses in other areas where similar storage problems exist. With the present invention, the CD 102 will carry one or more design themes.

The CD 102 will carry a number of designs and components for the creation of a design. It should be remembered that each design to be created by the user will include a number of individual layers which are overlaid one over the other by an operating computer 104 in order to create the design (such as document 106 in FIG. 1) and enable the user to view the design being constructed and created. The layers will include a layer (such as outline layer 202 in FIG. 2) that provides an outline so as to provide a final shape for the created design which is preferably configured so that the user can only see the part of the design that is in effect being used in the created design.

The outline may comprise a series of shapes, for example, suitable shapes which can be folded to form envelopes, such as shown at 204 in FIG. 2, including envelopes of the standard postage sizes. The remaining layers may comprise various aspects of the final design and may be formed from one or more suitable layers overlaid.

Each of these design layers 108, 110 may be themed and each design theme will include a number of components each of which can be selected from a number of variants (e.g., variant 1, variant 2, . . . in FIG. 1) in order to assemble the final design 106. The variations for the design of each theme will therefore be proportional to the number of components as well as the number of variants within each component. For example, if the theme has three layers each of which has ten variations then there are a total of 1000 designs that may be created. Using an embodiment of the current invention, storage needs to be provided for 30 designs only, whereas with the currently available design systems all 1000 final design possibilities would have had to be stored for retrieval.

A further advantage with the present invention is that a designer has the opportunity to see the design as it is being assembled and to make changes they wish at any stage rather than with the final assembled design. This gives the designer an opportunity to experiment with the design variables. Further advantages include:
a. user may print templates without wasting ink;
b. works on both European (A4) and USA (letter & legal) size paper-in fact the paper size doesn't matter; and
c. designs and overlays together are not dependent upon any bespoke or proprietary software program to be used.

As a comparison a currently available typical CD has 300 designs for a type A inserts and 300 designs (possibly the same designs) for a type B inserts meaning a total storage of 600 designs. Utilizing embodiments of the present invention and storing the components of the designs rather than the designs themselves means that storing 300 designs with 7 overlays in each of 10 colors (70 overlays in total) provides a total potential of 21000 designs for storage of 370 component parts.

The preceding description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A data storage system for use in forming documents, comprising a plurality of component elements or images that are selectable from at least two variants, and the components being overlaid to form a document having a plurality of layers, wherein each component and document is stored on a storage medium in a readily accessible format and each document includes the appropriate coding to activate the components selected for use with the document wherein, when opened, the document activates the components of the document, formatting them to the appropriate size, overlaying the components and displaying the opened document.

2. A data storage system as claimed in claim 1, wherein the layers of the document include an outline layer defining an outline shape for the design as well as specific design layers, the design including at least two layers.

3. A data storage system as claimed in claim 2, wherein the outline layer includes a layer that is configured to produce envelopes of predetermined shapes and sizes.

4. A data storage system as claimed in claim 2, wherein the outline layer is configured so that only the part of subsequent layers corresponding to the outline shape is visible to a user.

5. A data storage system as claimed in claim 1, wherein each of a number of designs stored on the storage medium and each of which designs comprises a selection of layers each of which layers is selected from at least two variants is stored in a readily accessible format and each design includes an appropriate coding to activate the variants selected for use with the design wherein, when opened, a particular design activates the various variant components making up the design and the activated variant components are appropriately sized and formatted for the particular design and displayed.

6. A data storage system for use with component overlaid design images in which a design image is created from a number of separate components layers that are selected and overlaid one over another to create the design image, and wherein the created design image includes a number of overlaid layers and each of the layers has corresponding selectable images which are storable as separate files on a storage medium and wherein the design image is created by assembly of the component layers and the information for a created design image is stored as a series of instruction for the creation of the design image.

7. A data storage system as claimed in claim 6, wherein the layers of the created design image include an outline layer defining an outline shape for the design as well as specific design layers, the design including at least two layers.

8. A data storage system as claimed in claim 7, wherein the outline layer includes a layer that is configured to produce envelopes of predetermined shapes and sizes.

9. A data storage system as claimed in claim 7, wherein the outline layer is configured so that only the part of subsequent layers corresponding to the outline shape is visible to a user.

10. A data storage system as claimed in claim 7, wherein each of a number of designs stored on the storage medium and each of which designs comprises a selection of layers each of which layers is selected from at least two variants is stored in a readily accessible format and each design includes an appropriate coding to activate the variants selected for use with the design wherein, when opened, a particular design activates the various variant components making up the design and the activated variant components are appropriately sized and formatted for the particular design and displayed.
